(19) United States
(12) Patent Application Publication
(10) Pub. No.: US 2003/0048196 A1
(43) Pub. Date: Mar. 13, 2003

(54) Signaling article identification system

(76) Inventor: David E. Lieberman, Milpitas, CA (US)

Correspondence Address: ROBERT D. VARITZ, P.C., 2007 S.E. Grant Street, Portland, OR, 97201, US

(21) Appl. No.: 10/231,817

(22) Filed: Aug. 29, 2002

Related U.S. Application Data
(60) Provisional application No. 60/318,910, filed on Sep. 10, 2001.

(51) Int. Cl. G08B 1/08

(52) U.S. Cl. 340/825.49; 340/539

(57) ABSTRACT

A jostle-responsive object finder system including a user carryable and activatable code-signal wireless transmitter, and an activatible signal receiver within an object unit which is attachable to an object of the user's choice, and responsive to such a code signal, but only after the occurrence of a jostle action which is delivered to the object unit, to initiate an attention-getting response detectable by the user.

### CROSS REFERENCE TO RELATED APPLICATION

This application claims priority to Provisional Application Serial No. 60/318,910, filed Sep. 10, 2001, entitled “Light-Signaling Article Identification System”, which application is hereby incorporated by reference.

### BACKGROUND AND SUMMARY OF THE INVENTION

This invention pertains to a wireless, transmitter/receiver, remote signaling/locating system, and in particular, to such a system which may be employed with respect to articles, such as luggage, for the purpose of aiding a user/owner in locating and correctly identifying his or her luggage in places, such as airport baggage-return areas. While many kinds of articles may be addressed by use of the present invention, a preferred embodiment herein is described in conjunction with a luggage-marking, or identification, system with respect to which the invention has been found to offer particular utility.

It is a well known issue to travelers that location of their luggage at a delivery point, such as in the baggage claim area of a major airport, has become a progressively more difficult and challenging issue as air travel, and luggage handling in relation thereto, continue to rise in volume. There are, of course, many different kinds of luggage which are shaped, colored and configured in such a fashion that many pieces look very much alike—factors which significantly impede rapid and correct location and identification by a user of his or her luggage. Delivered luggage is often so voluminous that one in fact experiences a delivery scene where pieces of luggage are piled many atop many, and even such measures as tying colored threads or ribbons to luggage as an aid often leads to still further confusion where like ribboning is fortuitously employed by many different travelers.

In this setting, there is clearly a need for a robust and reliable system and approach, and preferably some form of signaling electrical system and approach, for aiding luggage owners in their search for retrievable luggage. Among many factors which are important to consider, several stand out immediately as being quite important. To begin with, it is desirable that any approach which is employed to aid in locating and identifying luggage have a quality of singularity with respect to a searching user, whereby a response, for example, to a search request initiated by the user produces a response only from exactly the piece of luggage which the user is attempting to find. It is important that such a response be created in a manner whereby it is clearly communicable even in a quite chaotic situation with hundreds of passengers searching for hundreds of pieces of their luggage, all delivered in a common collection. A locating and signaling system ought, therefore, to produce on request a very distinctive and very unambiguous signal to a searching user.

Where electrical signaling is to be employed, as for example to trigger a flashing light, a distinctive sound, or some other electrically associated response, it is extremely important that any locating device attached to luggage be properly powerable and operable at the point in time of a user's search activity. Thus, ideally up to the point in time when the device is expected to respond to a search request, minimum, or no, power drain should characterize the behavior of such a luggage-attached device, whereby a user can have substantial confidence that adequate power will be available at the important time of luggage identification and retrieval. This condition of power conservancy is especially important where a user's travel itinerary is quite long, and luggage-identifying structure attached to the user's luggage must be in a fully powerable condition at the time of arrival despite a long transit (travel) time.

The present invention directly addresses these issues, and furnishes a system which meets all of the stated objectives in a very simple and satisfactory manner. More particularly, the present invention offers such a system which is based upon wireless radio-transmission communication, and very specifically upon such communication which becomes uniquely enabled by an event which does not require user participation, and even more specifically, by events which characterize activity that is taking place with direct reference to the usual end-of-travel luggage-delivery process. In other words, the system bases an important element of its operation upon luggage-delivery handling activity to trigger a signal-reception state. By performing in this manner, electrical power consumption prior to luggage delivery is either nil, or very minimal.

According to a preferred embodiment of the invention, two cooperative units are fundamentally employed. One is referred to herein as a user unit which is carried by a user, and which enables the user, at the time of searching for luggage, to send a wireless coded signal to the second principal unit made in accordance with the invention. The second unit is an object, or luggage-attachable, unit. The luggage-attachable unit includes a decoding and responding internal electrical structure, powered preferably by an internal battery, which structure responds to such a coded signal to produce a definitive and viable response, such as a blinking light response, when an appropriately transmitted and received coded signal coming from the user has been detected.

The electrical power-using capability, however, of the luggage-attachable unit to produce such a response is guarded according to an important and special feature of the invention. Very specifically, this capability requires a certain predetermined level of luggage jostling (also referred to herein as an article-experienced motion event) to transition internal circuitry from a low (or no) electrical power-usage standby state, or condition, to a more fully powered state ready to respond to a user's transmitted coded request signal. This guarding of capability is uniquely accomplished through the incorporation of an appropriate jostle-activation switch that responds, at least with momentary closure, to a predetermined level of luggage jostling. Momentary closure of this switch completes a circuit which then turns on and holds on for a pre-selected time period to enable, during that period, reception and decoding of any appropriate coded signal sent by the associated user. In accordance with the invention, adequate jostle activation for this purpose is established by typical luggage-delivery maneuvers, and such activation begins the just-mentioned pre-selected time period, called herein a first defined timing cycle, of preferably about 45-minutes, during which a user-transmitted coded signal of the right content can be received and responded to.

The condition of circuitry within the object unit (attached to luggage), before the occurrence of any “predetermined-level” jostle action, is referred to herein as a non-reception state. The condition of this circuitry after such jostle action, and during the existence of a first defined timing cycle, is referred to herein as a reception state.

When, during such a first defined timing cycle, a user employs the user-carryable unit to transmit a defined coded signal, appropriate signal-reception structure in the luggage-attachable unit creates a response, such as a blinking light response, physically associated with the luggage-attachable unit per se. Other kinds of responses are of course possible, and several of these will be more particularly mentioned below.

The proposed system thus offers an arrangement whereby very low overall power usage takes place, with significant power drain occurring only for a relatively short period of time after the occurrence of a jostle-activation event—an important characteristic of the invention which leads to reliably available electrical power at the end of an even quite long travel period. Relevant jostle activation, which occurs basically at the moment in time when a piece of luggage is being placed on a conveyor for display in a luggage-return area, obviously thus takes place essentially just at the right moment in time when a user is in that area seeking an identifying response in relation to the transmission of a coded inquiry signal.

If there are any earlier, large-enough jostling events, such as during typical normal luggage travel, these events will also each initiate what has been called herein a first defined timing cycle. However, experience has shown that even with several such “prior” events occurring, appropriate battery power will nonetheless be entirely adequate at the end of the usual normal travel situation.

These, and various other features and advantages that are offered by the present invention will become more fully apparent as the description which now follows is read in conjunction with the accompanying drawings.

### DESCRIPTION OF THE DRAWINGS

FIG. 1 is a simplified block/schematic diagram illustrating one form of a system made in accordance with the present invention.

FIG. 2 is a multiple-event timing diagram which helps to explain significant operations that take place in the behavior and operation of the system pictured in FIG. 1.

FIG. 3 is a simplified block/schematic diagram illustrating one modified form of the system pictured in FIG. 1.

### DETAILED DESCRIPTION OF THE INVENTION

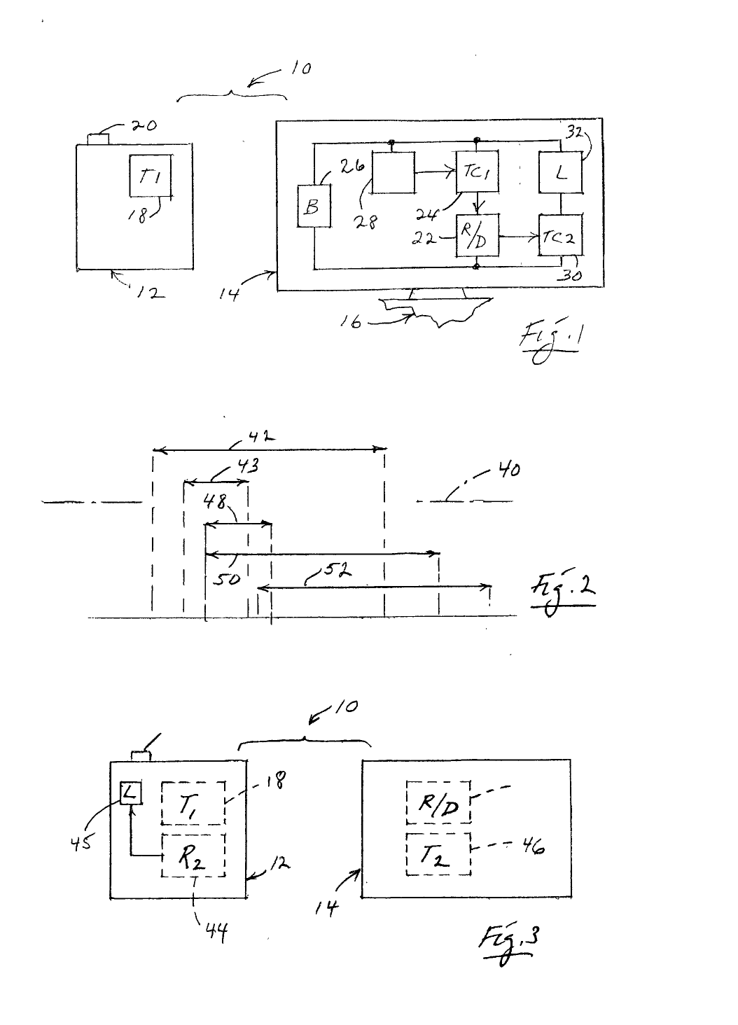

Turning now to the drawings, and referring first of all to FIG. 1, indicated generally at 10 is a jostle-responsive object finder system constructed in accordance with a preferred form of the present invention. Included in system 10 are what are referred to herein as a user unit 12 and an object unit 14. The bracket in FIG. 1 to which reference numeral 10 points is included in this figure to reflect the fact that units 12, 14 are operatively associated with one another, and it is between these two units that various communications, which will shortly be described, take place when the system is being employed by a user to find an object such as a piece of luggage.

In FIG. 1, shown fragmentarily at 16, is such a piece of luggage to which object unit 14 has been appropriately attached by the associated user at a point in time when, for example, the user is about to take a flight, and is checking luggage 16 for airline transport. The mechanism for attachment of unit 14 to luggage 16 forms no part of the present invention, and can take on any one of a number of different forms. In fact, and with respect to the FIG. 3 form of the invention which will shortly be described, unit 14 can be “attached” to a piece of luggage by being placed inside that luggage. In the FIG. 1 form of the invention, unit 14 is designed to function on the outside of a piece of luggage.

Included, inter alia, within user unit 12 are a coded signal transmitter 18 (also marked T1, and referred to as a first transmitter), an appropriate power-source battery for this transmitter (the power source not being specifically shown), and a user signaling switch (or switch button) 20, which herein is illustrated as a button that projects outwardly from the casing of unit 12. Unit 12 may be quite small in size, and could be, from that point of view, perhaps the size of a typical audio-recording tape cassette. Unit 12 is carried by the user to be employed when that user has arrived at a destination at which he or she wishes to send a coded signal (referred to herein as defined coded signal) to locate and identify luggage 16.

No detailed circuitry is shown within unit 12 herein, inasmuch as no part of this invention relies upon any particular special circuit construction. In fact, such circuit construction can take on a host of different styles, all conventional, and all well understood and known by those generally skilled in the art.

Object unit 14 includes: (a) a receiver/decoder circuit 22 (also marked R/D, and called a first receiver herein); (b) first timer circuitry 24 (also marked TC1) which is associated, as will be explained, with the operation of circuit 22; (c) a battery power source 26 (also marked B); (d) a jostle-activation switch represented in very simple block form at 28; (e) second timer circuitry 30 (also marked TC2); and (f) a lamp 32 (also marked L). Lamp 32 is visible on the outside of unit 14.

With regard to the collection of components illustrated in FIG. 1 that are contained in unit 14, there are several ways in which this unit may be delivered to the original purchaser and a user of unit 14. Preferably, the unit is delivered with battery 26 uninstalled, with the purchaser/user instructed how to install the battery before first use. This manner of supplying unit 14 assures that there is no chance for preliminary battery drain to take place, no matter what is the actual internal structure of the circuitry within unit 14. In other words, if this circuitry structure is constructed in such a manner that a certain very modest current drain begins as soon as a battery is installed, supplying the original purchaser of the unit with the battery uninstalled assures that, at least for the first time of use, full battery power is available from the first moment.

Another way of supplying unit 14 to the original purchaser is, of course, to supply the unit with no battery provided, with the first purchaser instructed simply to acquire and install a battery of the appropriate size and capacity before first use.

Still another way in which the first purchaser/user might be supplied unit 14 is with battery 26 in fact already in place, and with the circuitry inside the unit equipped with any one of a different number of specific forms of first-use-activation structure, which might typically take the form of a simple pull-away and discardable insulator that sits initially in any current flow path that might exist between the installed battery and other components in the circuitry.

All of these considerations with respect to initial conditions for unit 14 and battery 26 relate to concerns regarding operative battery life, and one practicing this invention can choose any one of these approaches purely as a matter of preference and choice.

Jostle-activation switch 28 can be constructed in a number of different ways, all well within the knowledge and skill of those skilled in the art, whereby a defined, predetermined level, or amount, of jostle action produces at least a momentary closure of this switch, the result of which will be explained shortly. As an illustration, switch 28 might take the form of an elongate, slender conductive electrode extending axially centrally within an elongate, cantilevered coil-spring conductor which wobbles with jostle action. Sufficient wobbling will cause it to contact, at least momentarily, the centered electrode. Another type of construction for switch 28 could feature piezoelectric behavior derived from a small deformation-sensitive piezoelectric piece of material which produces a detectable output signal whose magnitude is related to the amount of deformation. Such a signal could be detected electronically by a very low-power electronic detection circuit which becomes operative under a circumstance with battery 26 fully connected for use.

In the embodiment of unit 14 which is preferably employed, circuit 24 is internally equipped with an appropriate conventional holding circuit, or the like, which responds to momentary closure of switch 28 to close a current-supply circuit between battery 26, circuit 24 and receiver/decoder 22. In particular circuit 24 behaves very much like a self-holding, one-shot, monostable multivibrator which turns on to create the above-mentioned first defined timing cycle of preferably about 45-minutes.

The power-supply circuit which closes to energize receiver/decoder 22 with turning on of circuit 24 places the receiver/decoder in a reception state (transitions it from its non-reception state) ready to detect operation of transmitter 18.

Receiver/decoder circuit 22 is conventionally constructable in a number of different ways, and so is not detailed herein. Suffice it to say that when it is fully energized, an event which occurs as a consequence of momentary closure of the jostle-activation switch, followed by turning on of circuit 24, the receiver/decoder circuit is fully in a condition to receive and decode any appropriate coded signal which is transmitted by a user from transmitter 18 as a consequence of the user's having depressed switch button 20.

When and if, during the 45-minute first timing cycle thus initiated, the user at the location of unit 12 depresses button 20 to cause a coded signal to be transmitted by transmitter 18, this coded transmission is picked up and decoded by the decoder/receiver in unit 14. Such a coded transmission causes an energizing circuit to be established, now under the control of timing circuitry 30, for lamp 32, and specifically in a manner causing this lamp to blink or pulse throughout a second defined timing cycle which is determined by timing circuitry 30. This behavior, of course, assumes that the first timing cycle is still under way. It has been determined that a very effective length for the second defined timing cycle is about 4-6-seconds. Circuitry 30 and lamp 32 are collectively referred to herein as attention-getting response structure.

Turning attention now to FIG. 2 in the drawings, and referring first of all to that portion of this figure which lies above a dash-dot line presented at 40, here there are shown two, elongate, double-ended arrows and lines 42, 43 which represent, respectively, the mentioned first and second timing cycles. Specifically pictured here is a circumstance where the first timing cycle has begun before the second timing cycle. The second timing cycle, as shown, begins shortly after the beginning of the first timing cycle, and ends well before the end of the first timing cycle.

Accordingly, from the description just given for the construction, organization and operation of the circuitry in unit 14, and from studying the upper portion of FIG. 2, with battery 26 installed, and the system ready to perform, there is initially either no, or very little, power drain occurring with respect to the battery.

On jostle closure of switch 28, even momentarily, decoder/receiver circuit 22 in object unit 14 is placed in a state wherein it can receive and decode an appropriately transmitted coded signal sent from transmitter 18. When such a signal takes place, and assuming that it takes place within the first timing cycle that began with jostle-action closure of switch 28, circuit 30, which controls the onset and duration of the second timing cycle, energizes lamp 32 which blinks for a period of about 4-6-seconds.

It is thus clear that it is not user action which creates the moment in time that significant battery drain begins in unit 14. Rather, it is the occurrence of a jostle action that does this. Thus, and in effect, the operability of circuitry within unit 14 is linked to the very event (luggage delivery) which is generally contemporaneous with a user's desire to locate and identify luggage. This motion event is, of course, completely independent of any user activity.

Turning attention now to FIG. 3, here there is illustrated a modified form of system 10. Within unit 12 in system 10 as shown in FIG. 3, in addition to previously discussed transmitter 18, there is a wireless signal receiver shown by dashed block 44 (also marked R2 and called herein a second receiver). Further included in this version of unit 12 is an externally viewable, electrically energizable lamp 45 (also marked L).

Object block 14 as shown in FIG. 3 is modified (a) by the presence within it of a wireless signal transmitter shown in dashed lines at 46, and (b) by the absence of lamp 32. Transmitter 46 (which is also marked T2) is additionally referred to herein a second transmitter. These are the only fundamental modifications in unit 14 (as shown in FIG. 3) which differentiate it from unit 14 as shown in FIG. 1. Unit 14 is a device which can be “attached” to a piece of luggage by placing it suitably inside the luggage.

In the operation of system 10 as shown in FIG. 3, activation of the circuitry in unit 14 is essentially the same as that pictured and described earlier herein. Here, however, when, during a first timing cycle, the user transmits a coded signal, an end result of this transmission is that the second timing cycle control circuitry 30 energizes second transmitter 46. Energizing of this transmitter causes a signal to be sent by it which is received by second receiver 44 in unit 12. This action causes blinking energizing of just above-mentioned lamp 45 in unit 12. Lamp 45 and transmitter 46 are collectively referred to herein as attention-getting response structure.

Other variations that are somewhat related to what is pictured in FIG. 3 can include providing unit 12 with different kinds of output indicators of the transmission of a signal from transmitter 46. For example, reception of such a signal at the site of unit 12 could trigger the display of a row of lamps, the number of which that are lit giving the user an indication generally of how distant he or she is from the sought luggage. Another kind of output indicator which would give a sense of directionality along a line extending between the user and the sought luggage could also be employed.

In FIG. 2, below dash-dot line 40, the representative operations of further modifications are illustrated. For example, immediately below line 40 are two lines designated 48, 50. What these two lines show can be understood in relation to their lateral positions in FIG. 2 relative to line 42 above them. Thus, line 48 represents a circumstance wherein, shortly after a user's transmission act which has started the second timing cycle pictured by line 43 in FIG. 2, the user again quickly sends another coded signal before the ending of the cycle represented by line 43. What is shown here by lines 48, 50 is that a new second timing cycle is begun which can either be recognized within the continuing duration of the first timing cycle as pictured by line 42, or could be accommodated simultaneously with the initiation of a completely new overall first timing cycle, such as that represented by line 50 in FIG. 2.

At the base of FIG. 2 yet another modified performance is illustrated by a line 52. What this line shows, in relation to timing cycle line 42 above it, is that, if there is a second appropriate-level jostle event which occurs after a first significant jostle event, a completely new overall first timing cycle is then begun.

The system of this invention is thus simple, reliable and very versatile. By utilizing jostle events to trigger full activation of circuitry in the object unit, effective useable battery lifetime is greatly extended, and preparation for receiving a user's transmitted, coded “search” signal is effectively done at just the right moment in time when searching is likely to take place.

Various modifications may certainly be made, and those that have been specifically mentioned and illustrated herein are but suggestions of the wide versatility offered for tailoring the structure and operation of a system made in accordance with this invention.

I claim:

1. A jostle-responsive object finder system comprising
an activatable transmitter carryable by a user, operable to transmit a defined wireless coded signal, and
an activatible receiver attachable to an object of the user's choice, said receiver, when activated, being responsive to such a defined coded signal, but only after the occurrence of a pre-determined-level jostle action which is delivered to said receiver.

2. A jostle-responsive object finder system comprising
a user unit carryable by a user, and including an activatable first transmitter operable under user control to transmit a defined wireless coded signal,
an object unit attachable to an object of the user's choice, and including an activatable first receiver placeable selectively in either a non-reception or a reception state, placement of said first receiver in its said reception state occurring in relation to a predetermined-level jostle action delivered to said object unit, such a reception state being characterized by a first defined timing cycle, said first receiver including a coded-signal receiver/decoder operable, with said first receiver being in its said reception state, to receive and decode a then-received defined coded signal transmitted by said first transmitter, and
user attention-getting response structure operatively associated with said receiver/decoder in said object unit, and operable, upon reception and decoding of such a defined coded signal which occurs within said first defined timing cycle, to effect a user attention-getting response.

3. The system of claim 2, wherein said object unit further includes structure which is operable, in response to the effecting of a user attention-getting response, to confine the length of that response to a second defined timing cycle.

4. The system of claim 3, wherein said second defined timing cycle is shorter than said first defined timing cycle.

5. The system of claim 2, wherein said attention-getting response takes the form of a blinking light carried by said object unit.

6. The system of claim 3, wherein said attention-getting response takes the form of a blinking light carried by said object unit.

7. The system of claim 2, wherein said attention-getting response structure in said object unit includes a second wireless signal transmitter, said user unit includes a second receiver which is operatively associated with said second transmitter, and said attention-getting response takes the form of a visual indication produced at the location of said user unit via signal transmission from said second transmitter to said second receiver.

8. The system of claim 7, wherein said attention-getting response takes the form of a blinking light associated with the site of said user unit.

9. The system of claim 7, wherein said attention-getting response includes content effectively possessing a directional indication of the location of said second receiver relative to the location of said second transmitter.

10. The system of claim 3 which is designed whereby, if a second predetermined-level jostle action is delivered to said first receiver during the existence of a first defined timing cycle, a new first defined timing cycle is begun.

11. The system of claim 3, wherein the transmission by said first transmitter of a second defined coded signal during the existence of a second defined timing cycle initiates a new second defined timing cycle.

12. The method of claim 11, wherein the occurrence of a such a second defined coded signal also initiates a new first defined timing cycle.

13. A method relating to signal locating of a selected article comprising
attaching to the article a wireless coded-signal response device having both non-reception and reception states regarding an appropriately transmitted wireless coded signal, and normally occupying its said non-reception state, and
equipping that device to react to an article-experienced motion event to place the device in its said reception state.
